(19) United States
(12) Patent Application Publication
(10) Pub. No.: US 2013/0311506 A1
(43) Pub. Date: Nov. 21, 2013

(54) METHOD AND APPARATUS FOR USER QUERY DISAMBIGUATION

(71) Applicants: Gabriel Taubman, Brooklyn, NY (US); David Petrou, Brooklyn, NY (US); Hartwig Adam, Marina Del Rey, CA (US); Hartmut Neven, Malibu, CA (US)

(72) Inventors: Gabriel Taubman, Brooklyn, NY (US); David Petrou, Brooklyn, NY (US); Hartwig Adam, Marina Del Rey, CA (US); Hartmut Neven, Malibu, CA (US)

(73) Assignee: GOOGLE INC., Mountain View, CA (US)

(21) Appl. No.: 13/346,557

(22) Filed: Jan. 9, 2012

(51) Int. Cl. G06F 17/30

(52) U.S. Cl. 707/769; 707/E17.101; 707/E17.014

(57) ABSTRACT

A method and apparatus for enabling user query disambiguation based on a user context of a mobile computing device. According to embodiments of the invention, a first user search query, along with sensor data, is received from a mobile computing device. A recognition process is performed on the sensor data to identify at least one item. In response to determining the at least one item is a result for the first search query, data identifying the at least one item is transmitted to the mobile computing device as a response to the first search query. In response to determining the at least one item is not the result for the first search query, search results of a second search query is transmitted to the mobile computing device as the response to the first search query, the second search query comprising a query of the at least one item.

### TECHNICAL FIELD

Embodiments of the invention relate to the field of mobile computing devices, and more particularly, to enabling user query disambiguation based on a user context of a mobile computing device.

### BACKGROUND

A mobile computing device may include an image sensor (e.g., a camera) and/or an audio sensor (e.g., a microphone) to capture media data about people, places, and things a user of the mobile computing device encounters. When a user desires to obtain information regarding a visual or audio experience, he must first identify an object related to that experience, and then submit a clear unambiguous query for that identified object. What is needed is a process to enable a user to quickly enter a query and utilize data related to a user context of a mobile computing device to specify any ambiguous terms from the user query.

### SUMMARY

A method and apparatus for enabling user query disambiguation based on a user context of a mobile computing device. According to embodiments of the invention, a first user search query, along with sensor data, is received from a mobile computing device. A recognition process is performed on the sensor data to identify at least one item. In response to determining the at least one item is a result for the first search query, data identifying the at least one item is transmitted to the mobile computing device as a response to the first search query. In response to determining the at least one item is not the result for the first search query, search results of a second search query is transmitted to the mobile computing device as the response to the first search query, the second search query comprising a query of the at least one item.

These and other aspects and embodiments are described in detail in the drawings, the description, and the claims.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of a system architecture for receiving and disambiguating user queries according to an embodiment of the invention.

FIG. 2 is a flow diagram of a process for disambiguating user queries based on captured media data according to an embodiment of the invention.

FIG. 3 is a flow diagram of a process for capturing media data and disambiguating user queries according to an embodiment of the invention.

FIG. 4 is a block diagram of image data used to disambiguate a user query according to an embodiment of the invention.

FIG. 5A-5B is an illustration of sensor data used to disambiguate a series of user queries according to an embodiment of the invention.

FIG. 6 is an illustration of a mobile computing device to utilize an embodiment of the invention.

FIG. 7 illustrates an example computer network infrastructure for capturing and transmitting data according to an embodiment of the invention.

### DETAILED DESCRIPTION

Embodiments of an apparatus, system and method for enabling user query disambiguation based on a user context of a mobile computing device are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

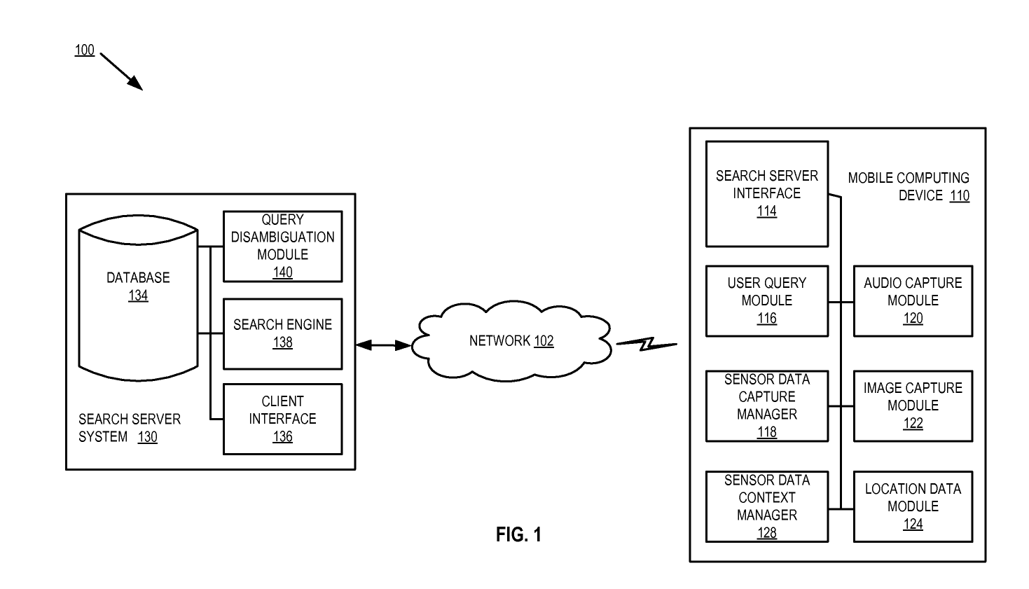

FIG. 1 is a block diagram of a system architecture for receiving and disambiguating user queries according to an embodiment of the invention. System 100 includes mobile client device 110 and search server system 130. Mobile client device 110 may be a mobile computing device, such as a mobile telephone, personal digital assistant, tablet computer, wearable computing device, etc. Search server system 130 may also be a computing device, such as one or more server computers, desktop computers, etc.

Mobile client device 110 and search server system 130 may be communicatively coupled via network 102 using any of the standard network protocols for the exchange of information. In one embodiment, mobile client device 110 is coupled with network 102 via a wireless connection, such as a cellular telephone connection, wireless fidelity connection, etc. Mobile client device 110 and search server system 130 may run on one Local Area Network (LAN) and may be incorporated into the same physical or logical system, or different physical or logical systems. Alternatively, mobile client device 110 and search server system 130 may reside on different LANs, wide area networks, cellular telephone networks, etc. that may be coupled together via the Internet but separated by firewalls, routers, and/or other network devices. It should be noted that various other network configurations can be used including, for example, hosted configurations, distributed configurations, centralized configurations, etc.

In this embodiment, mobile client device 110 is able to capture digital image data with a digital camera (not shown) and capture audio data with a microphone (not shown) included in the mobile device. The captured digital image data may include still digital photographs, a series of digital photographs, recorded digital video, a live video feed, etc. The captured audio data may include audio samples, audio signatures, audio data associated with recorded video data, a live audio feed, etc. Mobile client device 110 may be implemented as a binocular wearable computing device, a monocular wearable computing device, as well as a cellular telephone, a tablet computer, or otherwise.

In this embodiment, mobile client device 110 includes search server interface 114, user query module 116, sensor data capture manager 118, audio capture module 120, image capture module 122, location data module 124, and sensor data context manager 128. Search server system 130 may include database 134, client interface 136, search engine 138, and query disambiguation module 140.

User query module 116 accepts search queries from a user of mobile computing device 110. Said queries may be text, audio or visual (i.e., image data) data for submitting to search engine 138 of search server system 130. Search engine 138 may comprise a general web search engine or a specialized search engine for a specific application, such as a search tool for a social networking service.

Sensor data capture manager 118 may receive sensor data from any of audio capture module 120, image capture module 122, and location data module 124. Audio capture module 120 captures digital audio data including music, conversations that convey data such as names, places, and news events, etc. Image capture module 122 captures digital image data of people, as well as real-world objects such as places or things, etc. Location data module 124 captures location data (captured, for example, from a Global Positioning System (GPS) or via Cell Tower triangulation) that identifies the location of mobile client device 110. In one embodiment, sensor data capture manager 118 generates digital signatures for objects within image data captured by image capture module 122 and/or selects audio samples or generates digital signatures from audio data captured by audio capture module 120; this data is combined with location data captured from location data module 124 and then transmitted by search server interface 114 to client interface 136 of search server system 130.

It is possible for user queries received by user query module 116 to contain no ambiguity—e.g., queries such as “Empire State Building” or “where is the Empire State Building” are specific enough for search engine 138 to provide adequate search results. Other queries submitted by a user in a real-world environment may be ambiguous—e.g., “what am I looking at” or “tell me more about this building in front of me” while the viewer is viewing or in front of the Empire State Building; said ambiguous queries require additional data in order for search engine 138 to provide adequate search results.

When an ambiguous user query (captured via user query module 116) and sensor data (i.e., any of digital image, data digital audio data and location data) captured by sensor data capture manager 118 are received by search server system 130, query disambiguation module 140 performs recognition processes on the sensor data to obtain data related to the user's current context; this data is used to disambiguate user queries—i.e., translate the user query into a more specified query in order for search engine 138 to provide adequate results.

For example, the above described ambiguous user query “what am I looking at” may be accompanied by image data representing the user's current view; query disambiguation module 140 performs an image recognition process on said image data to identify the building in front of the user (in this example, the Empire State Building). In another example, the above described ambiguous user query “tell me more about this building in front of me” may be accompanied by image data representing the user's current view or location and compass information indentifying the user's current location and orientation to interpret said query as requesting information about the building in front of the user (in this example, the Empire State Building). In some embodiments, a second disambiguated query is created and submitted to search engine 138 to produce search results based on data included in database 134 (e.g., “tell me more about this building in front of me” is converted into a second query “tell me about the Empire State Building”).

Sensor data context manager 126 determines when to transmit sensor data. In some embodiments, sensor data is transmitted based on an analysis of the current user query. For example, sensor data context manager 126 may determine whether the user query includes ambiguous terms, and if so, what sensor data will identify the proper context to disambiguate the user query (i.e., determine whether visual, audio and/or location data is appropriate to send to client interface 136 of search server system 130). In other embodiments, there is no determination by the mobile client device as to which data is sent along with the user query. For example, a user command may initiate the transmission of sensor data, search server system 130 may request specific sensor data, sensor data may be transmitted to search server system 130 before the user query, all sensor data captured may be sent to search server system 130 along with the user query, etc.

When client interface 136 receives digital image data and/or audio data, said interface may generate digital signatures for objects within the received image data and selects audio samples from the received audio data. However, as discussed above, client interface 136 may also receive image signatures and audio samples, and thus does not generate the signatures and samples. In one embodiment, client interface 136 utilizes the digital image signatures and/or audio samples to perform one or more recognition processes on the media data to attempt to determine specific objects, people, places, etc. within digital image data, or determine words, a song, a person's voice, known audio signatures, etc., within audio data. Query disambiguation module 140 and search engine 138 may utilize the image signatures and/or audio samples to provide search results for the user's query.

In this embodiment, client interface 136 transmits search results to search server interface 114 of mobile client device 110 for presenting the results to the user. Mobile client device may present the search results either audibly or visually. For example, said data may be formatted for augmenting a live view of the user of the mobile computing device, so that search results are displayed proximate to the queried object within the view.

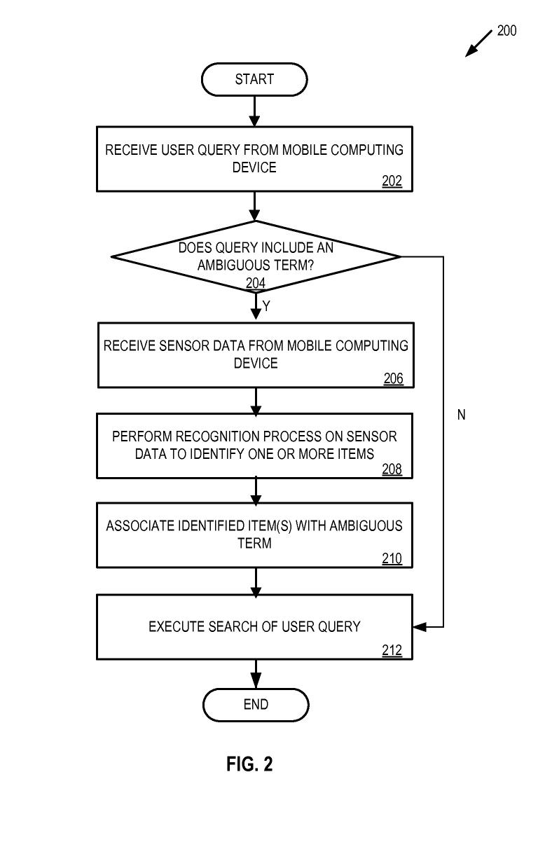

FIG. 2 is a flow diagram of a process for disambiguating user queries based on captured media data according to an embodiment of the invention. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions may be performed in parallel. Additionally, one or more actions can be omitted in various embodiments of the invention; thus, not all actions are required in every implementation. Other process flows are possible.

Process 200 is performed by processing logic that may comprise hardware (circuitry, dedicated logic, etc.), software (such as is run on a general purpose computer system or a dedicated machine), firmware, or a combination. Process 200 may be performed by a server device (e.g., search server system 130 of FIG. 1).

A user query is received from a mobile computing device (processing block 202). In order to execute a search of the user query, it is determined whether the query includes one or more ambiguous terms (processing block 204). Examples of user queries requiring disambiguation include “what song is playing now,” “tell me about this painting,” “give me reviews for this car,” etc. If the received user query does not require disambiguation, a search is executed for the user query (processing block 212).

If the received user query does require disambiguation, sensor data related to the context of the user query (e.g., image data, audio data, location data) is received (processing block 206) and analyzed (processing block 208) to identify one or more items. While sensor data is illustrated to be received after the user query from the mobile computing device, in other embodiments of the invention said sensor data may be received after or simultaneous with the user query received from the mobile computing device.

In one embodiment, where processing logic receives media data and not image signatures and/or audio samples, processing logic generates the digital signatures for the objects within the received digital image data, and selects audio samples from received digital audio data; processing logic utilizes the digital image signatures to search for real world objects, places or persons with matching image signatures. Furthermore, processing logic utilizes samples of audio to search for audio, such as songs, known voice signatures, etc., that match the audio samples. These items are associated with the ambiguous query terms (processing block 210) in order to execute the search of the user query (processing block 212)—i.e., any query terms with ambiguity are resolved based on the identified items. For example, if the user query “give me reviews for this car” is accompanied image data of an automobile, a search for review data related to the identified automobile is executed by submitting a second user query based on the first user query and the ambiguous terms replaced with the indentified automobile—e.g., “give me reviews for [automobile make/model].”

Sensor data may also comprise previous audio search queries. For example, if a user submits the query “tell me about this painting I am looking at” along with image data of a painting, processing is executed to indentify the painting, and information is presented to the user about the painting, including the artist of the painting. If the user submits a subsequent query “what else did he paint,” processing may resolve the ambiguous term “he” by associating the term with the artist identified in the search results of the previous user query.

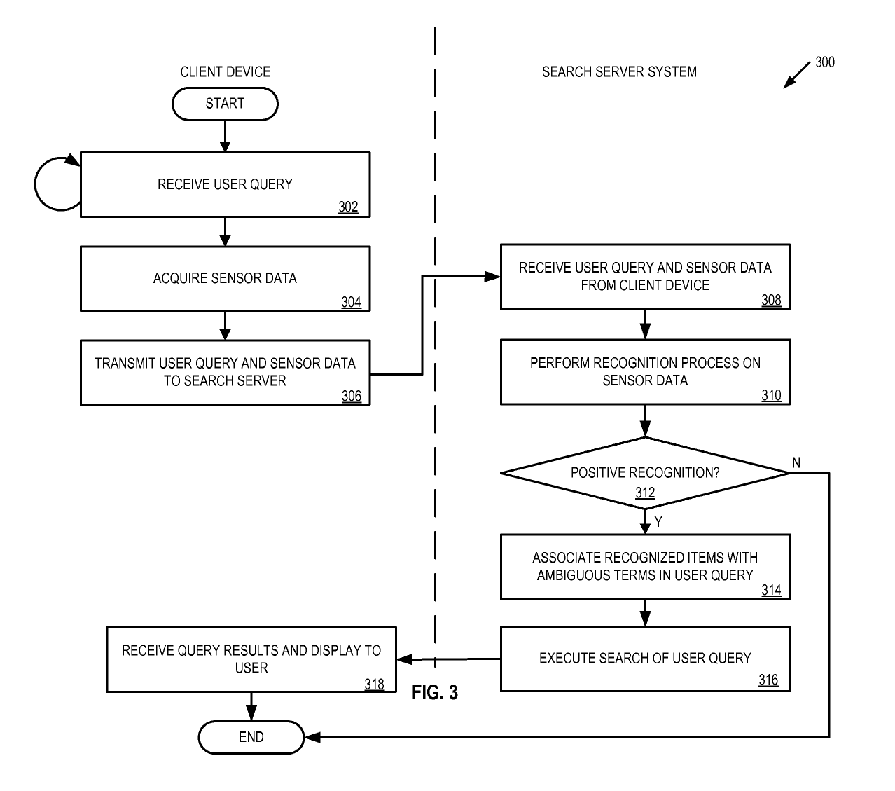

FIG. 3 is a flow diagram of a process for capturing media data and disambiguating user queries according to an embodiment of the invention. Process 300 may be performed by a client device and server device (e.g., mobile client device 110 and search server system 130 of FIG. 1).

A client device may receive a query from a user (processing block 302). While the example queries discussed below are audio queries, user queries may any combination of text, audio or visual (i.e., image data) data for submitting to a search engine.

The client device further acquires sensor data associated with the user query (processing block 304). In some embodiments, the sensor data is acquired based on a user command input to the mobile computing device. For example, the user may press a button or key while submitting an audio query such as “what am I looking at” to initiate the capture of image data. In other embodiments, the user query may be analyzed, by either the client device or the intended search server system recipient, to determine whether sensor data is required to disambiguate the user query, and the client device or search server system may issue a command to initiate the capture of sensor data. The client device transmits the user query along with the sensor data to the search server system (processing block 306). Embodiments of the invention may send the user query and sensor data to the search server system in any order.

Upon receiving the user query and sensor data from the client device (processing block 308), the search server system performs a recognition process on the sensor data to identify any potential objects related to the ambiguous query terms (processing block 310). For example, if the user submits the query “what am I listening to,” the search server system attempts to identify any audio content from the sensor data.

If there is no recognizable object from the sensor data—i.e., no identifiable objects to disambiguate the user query, then no search is executed for the user query. If there is a recognizable object from the user query (processing block 312), the recognizable object is associated with ambiguous terms in the user query (processing block 314). A search for the query is executed (316), which may include submitting a second, disambiguated query to a search engine; however, the result of the query may be the data obtained from the recognition process. For example, if the user submits the query “what am I listening to” and the sensor data is processed to identify the song, the result for the query is data identifying the song, and search engine processing is not necessary in order to answer the user's query. Query results are received by the client device and displayed to the user (processing block 318).

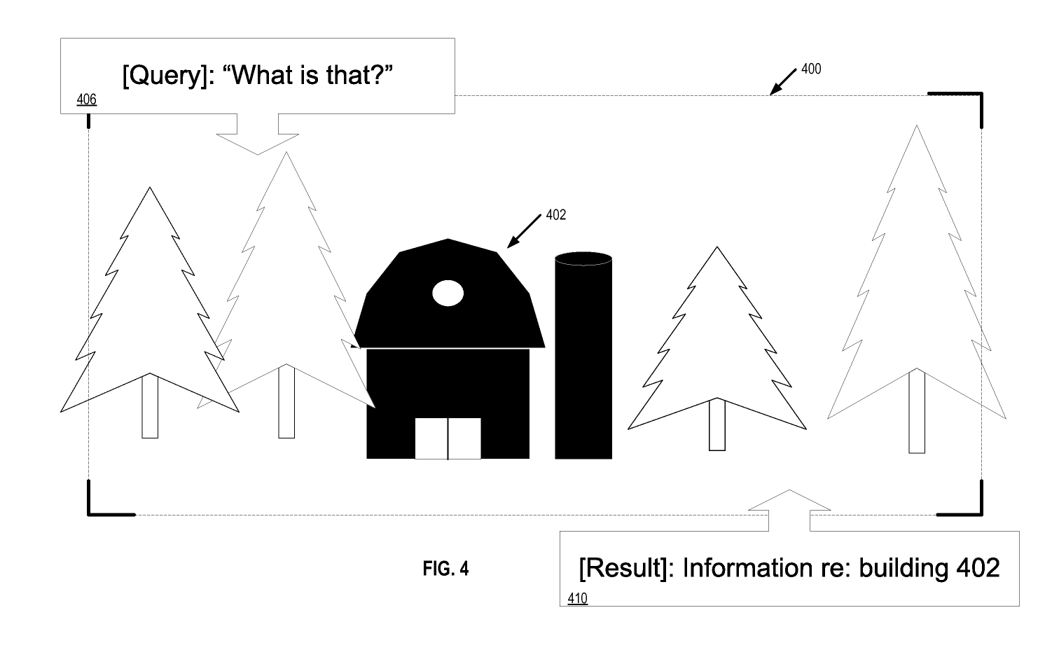

FIG. 4 is a block diagram of image data used to disambiguate a user query according to an embodiment of the invention. In this example, user query 406 (shown as the question “What is that?”) in of itself is too ambiguous to generate any search results. Image data 400 is captured at relatively the same time the user submits query 406 to a mobile client device. Image processing is executed, either at the mobile client device or at the recipient search server, to identify building 402 from image data 400. Additional processing of query 406 is executed to determine whether building 402 disambiguates query 406 (in this example, the object of the preposition “that” is determined to be building 402).

In some embodiments, the identification of building 402 may be a sufficient result for query 406. In this embodiment, an additional query for more information for building 402 is submitted, and is provided to the user as result 410. Said result may be communicated to the user audibly or visually. For example, if the mobile computing device comprises a user wearable computing device with a heads-up display, result 410 may be displayed to augment a live view of building 402.

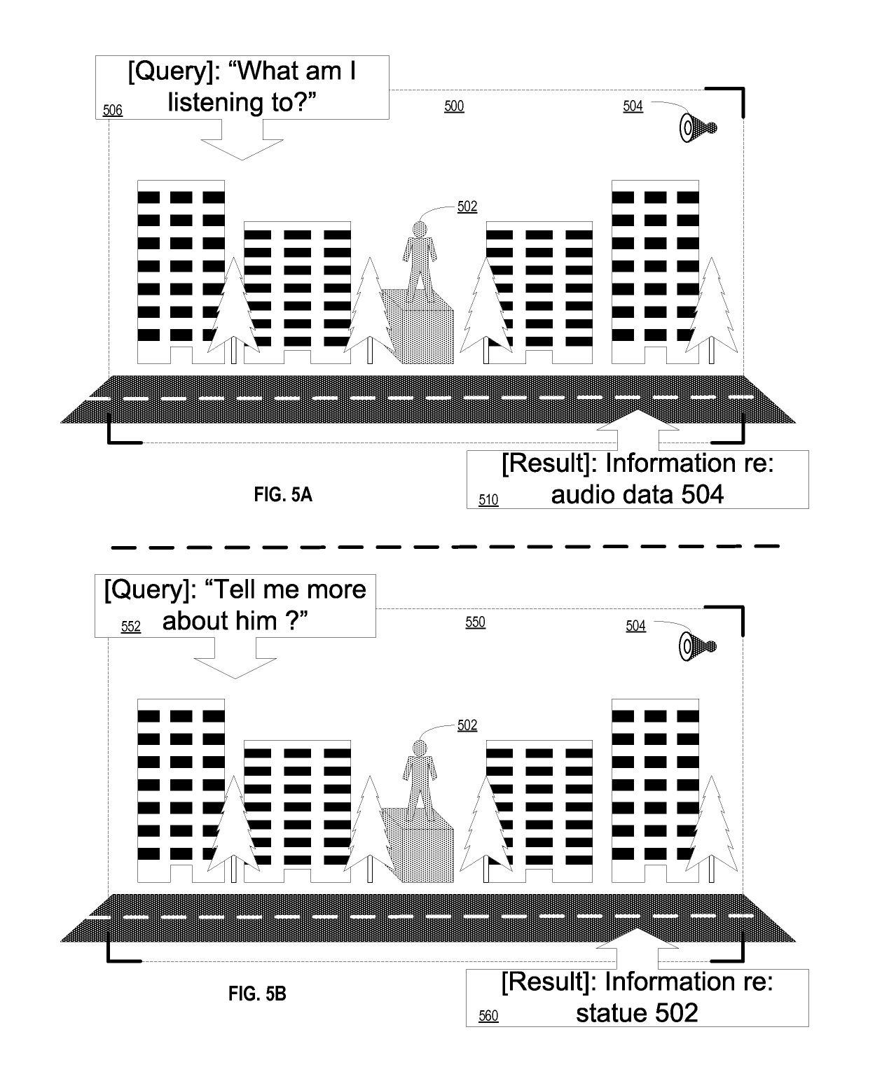

FIG. 5A-5B is an illustration of sensor data used to disambiguate a series of user queries according to an embodiment of the invention. In the example illustrated in FIG. 5A, user query 506 (shown as the question “What am I listening to?”) in of itself is too ambiguous to generate any search results. Image data 500 and audio data 504 (shown as a symbol for the purpose of showing the audio data captured around the same time as the image data) are captured at relatively the same time the user submits query 506 to a mobile computing device. Additional processing of query 506, either at the mobile client device or at the recipient search server, is executed to determine which data to perform recognition processes on. In this example, the term “listening” indicates audio data 504 should be processed to produce result 510.

The identification of audio data 504 may be a sufficient result to query 506. In this example, however, an additional query for more information for audio data 504 is submitted, and is provided to the user as answer 510. Said answer includes a data identifying the creator of said audio data (e.g., a performing artist of the song).

In the example illustrated in FIG. 5B, user query 552 (shown as the query “Tell me more about him”) in of itself is too ambiguous to generate any search results. Image data 550 and audio data 504 (shown as a symbol further the purpose of pointing out the data) are captured at relatively the same time the user submits query 552. Additional processing of query 552 is executed to determine which data to perform recognition processes on. In this example, the question may apply to statue 502, or to the aforementioned creator of audio data 504. If query 552 was submitted is a sufficiently short amount of time after query 506, it may be determined that the ambiguous query term “him” is to be associated with the creator of audio data 504. In this example, however, query 552 was submitted past a threshold amount of time such that the results of query 506 are not considered with disambiguating the current query; image data 550 is processed to identify the object at the center of the image (in this example, statue 502). The result of this processing is used to provide query result 560, which comprises information regarding statue 502.

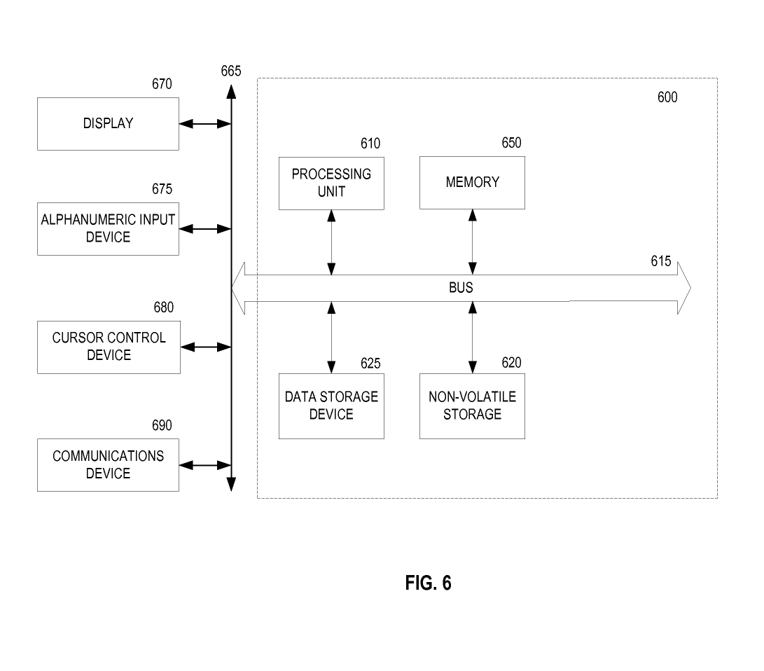

FIG. 6 is an illustration of a mobile computing device to utilize an embodiment of the invention. Platform 600 as illustrated includes bus or other internal communication means 615 for communicating information, and processor 610 coupled to bus 615 for processing information. The platform further comprises random access memory (RAM) or other volatile storage device 650 (alternatively referred to herein as main memory), coupled to bus 615 for storing information and instructions to be executed by processor 610. Main memory 650 also may be used for storing temporary variables or other intermediate information during execution of instructions by processor 610. Platform 600 also comprises read only memory (ROM) and/or static storage device 620 coupled to bus 615 for storing static information and instructions for processor 610, and data storage device 625 such as a magnetic disk or optical disk and its corresponding disk drive. Data storage device 625 is coupled to bus 615 for storing information and instructions.

Platform 600 may further be coupled to display device 670, such as a cathode ray tube (CRT) or a liquid crystal display (LCD) coupled to bus 615 through bus 665 for displaying information to a computer user. Alphanumeric input device 675, including alphanumeric and other keys, may also be coupled to bus 615 through bus 665 for communicating information and command selections to processor 610. An additional user input device is cursor control device 680, such as a mouse, a trackball, stylus, or cursor direction keys coupled to bus 615 through bus 665 for communicating direction information and command selections to processor 610, and for controlling cursor movement on display device 670. In embodiments utilizing a touch screen interface, it is understood that display 670, input device 675 and cursor control device 680 may all be integrated into a touch-screen unit.

Another device, which may optionally be coupled to platform 600, is a communication device 690 for accessing other nodes of a distributed system via a network. Communication device 690 may include any of a number of commercially available networking peripheral devices such as those used for coupling to an Ethernet, token ring, Internet, or wide area network. Communication device 690 may further be a null-modem connection, or any other mechanism that provides connectivity between computer system 600 and the outside world. Note that any or all of the components of this system illustrated in FIG. 6 and associated hardware may be used in various embodiments of the invention.

It will be appreciated by those of ordinary skill in the art that any configuration of the system illustrated in FIG. 6 may be used for various purposes according to the particular implementation. The control logic or software implementing embodiments of the invention can be stored in main memory 650, mass storage device 625, or other storage medium locally or remotely accessible to processor 610.

It will be apparent to those of ordinary skill in the art that any system, method, and process to disambiguate user queries based on mobile computing device context as described herein can be implemented as software stored in main memory 650 or read only memory 620 and executed by processor 610. This control logic or software may also be resident on an article of manufacture comprising a computer readable medium having computer readable program code embodied therein and being readable the mass storage device 625 and for causing processor 610 to operate in accordance with the methods and teachings herein.

Embodiments of the invention may also be embodied in a handheld or portable device containing a subset of the computer hardware components described above. For example, the handheld device may be configured to contain only the bus 615, the processor 610, and memory 650 and/or 625. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the invention for such a device would be apparent to one of ordinary skill in the art given the disclosure of the present invention as provided herein.

Embodiments of the invention may also be embodied in a special purpose appliance including a subset of the computer hardware components described above. For example, the appliance may include processor 610, data storage device 625, bus 615, and memory 650, and only rudimentary communications mechanisms, such as a small touch-screen that permits the user to communicate in a basic manner with the device. In general, the more special-purpose the device is, the fewer of the elements need be present for the device to function.

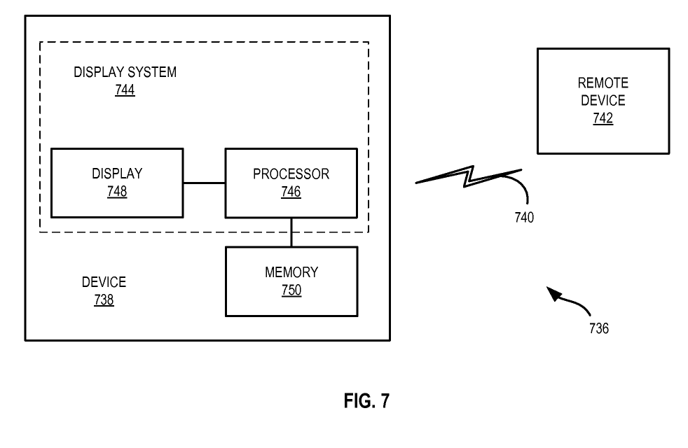

FIG. 7 illustrates an example computer network infrastructure for capturing and transmitting data according to an embodiment of the invention. In system 736, device 738 communicates using communication link 740 (e.g., a wired or wireless connection) to remote device 742. Device 738 may be any type of device that can receive data and display information corresponding to or associated with the data. For example, device 738 may be a heads-up display system, such as the eyeglasses 902 shown in FIGS. 9A and 9B.

Device 738 includes display system 744 comprising processor 746 and display 748. Display 748 may be, for example, an optical see-through display, an optical see-around display, or a video see-through display. Processor 746 may receive data from remote device 742, and configure the data for display. Processor 746 may be any type of processor, such as a micro-processor or a digital signal processor, for example.

Device 738 may further include on-board data storage, such as memory 750 coupled to processor 746. Memory 750 may store software that can be accessed and executed by processor 746, for example.

Remote device 742 may be any type of computing device or transmitter including a laptop computer, a mobile telephone, etc., that is configured to transmit data to device 738. Remote device 742 and device 738 may contain hardware to enable communication link 740, such as processors, transmitters, receivers, antennas, etc.

Communication link 740 is illustrated as a wireless connection; however, wired connections may also be used. For example, communication link 740 may be a wired link via a serial bus such as a universal serial bus or a parallel bus. A wired connection may be a proprietary connection as well. Communication link 740 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. Remote device 742 may be accessible via the Internet and may comprise a computing cluster associated with a particular web service (e.g., social-networking, photo sharing, address book, etc.) to receive captured media data as described above.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

Some portions of the detailed description above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent series of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion above, it is appreciated that throughout the description, discussions utilizing terms such as “capturing,” “transmitting,” “receiving,” “parsing,” “forming,” “monitoring,” “initiating,” “performing,” “adding,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the method operations. The required structure for a variety of these systems will appear from the description above. In addition, embodiments of the invention are not described with reference to any particular programming language. It will be appreciated that a variety of programming languages may be used to implement the teachings of the invention as described herein.

The present description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

1. A method comprising:
receiving a first search query of a user of a mobile computing device, the first search query comprising an incomplete search query, wherein one or more ambiguous query terms cause the first search query to be incomplete, the one or more ambiguous query terms including a pronoun;
receiving sensor data from the mobile computing device, the sensor data captured via a sensor with the mobile computing device;
performing a recognition process on the sensor data to identify at least one item from the sensor data to complete the first search query by resolving the pronoun of the one or more ambiguous query terms with the data identifying the at least one item;
in response to determining the completed first search query comprises a request to identify the at least one item is a result for the first search query, transmitting data identifying the at least one item to the mobile computing device as a response to the first search query; and
in response to determining the completed first search query does not comprise a query to identify the at least one item, transmitting search results of a second search query to the mobile computing device as the response to the first search query, the second search query comprising a query related to the at least one item.

2. (canceled)

3. The method of claim 1, wherein the first search query comprises a request for information of one or more ambiguous query terms, and wherein the at least one item is not the result for the first search query, the method further comprising:
creating the second search query based on the resolved one or more ambiguous query terms.

4. The method of claim 3, wherein the first search query comprises an audio search query, the method further comprising:
performing a speech recognition process on the audio search query to identify the one or more ambiguous query terms; and
creating the second query based on the first query and the one or more ambiguous query terms replaced with one or more query terms identifying the at least one item.

5. The method of claim 1, wherein the sensor data includes image data, the method further comprising:
identifying an image signature associated with the at least one item.

6. The method of claim 1, wherein the sensor data includes audio data, and wherein the at least one item comprises an audio file, the method further comprising:
identifying an audio signature associated with the audio file.

7. The method of claim 1, wherein the sensor data includes location data, and wherein the at least one item comprises a specific location.

8. The method of claim 1, wherein the sensor data comprises a plurality of media data files captured within a time frame.

9. The method of claim 8, wherein the at least one item comprises a recurring item included in more than one of the plurality of media data files.

10. The method of claim 1, wherein the mobile computing device comprises a user wearable computing device, the sensor comprises a head mounted sensor, and the sensor data comprises image data of an external scene viewed by the user of the mobile computing device.

11. A non-transitory computer readable storage medium including instructions that, when executed by a processor, cause the processor to perform a method comprising:
receiving a first search query of a user of a mobile computing device, the first search query comprising an incomplete search query, wherein one or more ambiguous query terms cause the first search query to be incomplete, the one or more ambiguous query terms including a pronoun;
receiving sensor data from the mobile computing device, the sensor data captured via a sensor with the mobile computing device;
performing a recognition process on the sensor data to identify at least one item from the sensor data to complete the first search query by resolving the pronoun of the one or more ambiguous query terms with the data identifying the at least one item;
in response to determining the completed first search query comprises a request to identify the at least one item, transmitting data identifying the at least one item to the mobile computing device as a response to the first search query; and
in response to determining the at least one item is not the result for the completed first search query does not comprise a query to identify the at least one item, transmitting search results of a second search query to the mobile computing device as the response to the first search query, the second search query comprising a query related to the at least one item.

12. (canceled)

13. The non-transitory computer readable storage medium of claim 11, wherein the first search query comprises a request for information of one or more ambiguous query terms, and wherein the at least one item is not the result for the first search query, the method further comprising:
creating the second search query based on the resolved one or more ambiguous query terms.

14. The non-transitory computer readable storage medium of claim 13, wherein the first search query comprises an audio search query, the method further comprising:
performing a speech recognition process on the audio search query to identify the one or more ambiguous query terms; and
creating the second query based on the first query and the one or more ambiguous query terms replaced with one or more query terms identifying the at least one item.

15. The non-transitory computer readable storage medium of claim 11, wherein the sensor data includes image data, the method further comprising:
identifying an image signature associated with the at least one item.

16. The non-transitory computer readable storage medium of claim 11, wherein the sensor data includes audio data, and wherein the at least one item comprises an audio file, the method further comprising:
identifying an audio signature associated with the audio file.

17. The non-transitory computer readable storage medium of claim 11, wherein the sensor data includes location data, and wherein the at least one item comprises a specific location.

18. The non-transitory computer readable storage medium of claim 11, wherein the sensor data comprises a plurality of media data files captured within a time frame.

19. The non-transitory computer readable storage medium of claim 18, wherein the at least one item comprises a recurring item included in more than one of the plurality of media data files.

20. The non-transitory computer readable storage medium of claim 11, wherein the mobile computing device comprises a user wearable computing device, the sensor comprises a head mounted sensor, and the sensor data comprises image data of an external scene viewed by the user of the mobile computing device.

21. A system comprising:
a memory;
a processor; and
a query module included in the memory and executed via a processor to:
receive a first search query of a user of a mobile computing device the first search query comprising an incomplete search query, wherein one or more ambiguous query terms cause the first search query to be incomplete, the one or more ambiguous query terms including a pronoun;
receive sensor data from the mobile computing device, the sensor data captured via a sensor with the mobile computing device;
perform a recognition process on the sensor data to identify at least one item from the sensor data to complete the first search query by resolving the pronoun of the one or more ambiguous query terms with the data identifying the at least one item;
in response to determining the completed first search query comprises a request to identify the at least one item, transmit data identifying the at least one item to the mobile computing device as a response to the first search query; and
in response to determining the completed first search query does not comprise a query to identify the at least one item, transmit search results of a second search query to the mobile computing device as the response to the first search query, the second search query comprising a query related to the at least one item.

22. (canceled)

23. The system of claim 21, wherein the first search query comprises a request for information of one or more ambiguous query terms, and wherein the at least one item is not the result for the first search query, the query module to further:
create the second search query based on the resolved one or more ambiguous query terms.

24. The system of claim 23, wherein the first search query comprises an audio search query, the query module to further:
perform a speech recognition process on the audio search query to identify one or more ambiguous query terms;
create the second query based on the first query and the one or more ambiguous query terms replaced with one or more query terms identifying the at least one item.

25. The system of claim 21, wherein the sensor data includes image data, the query module to further:
identify an image signature associated with the at least one item.

26. The system of claim 21, wherein the sensor data includes audio data, and wherein the at least one item comprises an audio file, the query module to further:
identify an audio signature associated with the audio file.

27. The system of claim 21, wherein the sensor data includes location data, and wherein the at least one item comprises a specific location.

28. The system of claim 21, wherein the sensor data comprises a plurality of media data files captured within a time frame.

29. The system of claim 28, wherein the at least one item comprises a recurring item included in more than one of the plurality of media data files.

30. The system of claim 21, wherein the mobile computing device comprises a user wearable computing device, the sensor comprises a head mounted sensor, and the sensor data comprises image data of an external scene viewed by the user of the mobile computing device.
